(19) United States
(12) Patent Application Publication
(10) Pub. No.: US 2005/0018399 A1
(43) Pub. Date: Jan. 27, 2005

(54) Electronic apparatus with cooling fan

(75) Inventor: Masato Shimizu, Tokyo (JP)

Correspondence Address: YOUNG & THOMPSON, 745 SOUTH 23RD STREET, 2ND FLOOR, ARLINGTON, VA, 22202, US

(73) Assignee: HIT CO., LTD., TOKYO (JP)

(21) Appl. No.: 10/863,780

(22) Filed: Jun. 9, 2004

(30) Foreign Application Priority Data
Jun. 10, 2003 (JP) 2003-164675

(51) Int. Cl. G06F 1/20

(52) U.S. Cl. 361/695; 361/687

(57) ABSTRACT

At least one fan for sending cooling air into an apparatus case is attached to a rear or side surface of the apparatus case. A drawer to which a server unit is attached is installed into and pulled out from a front surface side of the apparatus case by being guided by guide members. Since a cutout is formed in a side plate and a rear plate of the drawer, the cooling air from the fan is provided to the server unit after passing through the cutout, so that the server unit is cooled effectively.

### BACKGROUND OF THE INVENTION

1. Field of the Invention

The present invention relates to an electronic apparatus in which plural circuit units are contained in a drawable manner, and more specifically, to an electronic apparatus having a fan for cooling each circuit unit effectively.

2. Description of the Prior Arts

A rack-type container is used in many electronic apparatus. The container is constituted of a case having the shape of a box of which a front surface is open and plural drawers in which a circuit unit is mounted. The drawers are freely inserted into or pulled out from the front surface of the case. As the example of such electronic apparatus, there is a server apparatus for providing various services to the terminals connected in a network. A file server which makes user share files in the network, a print server for administrating a printer in the network, and an e-mail server for sending and receiving the e-mail are unitized in the server apparatus. Each server is assembled in the drawer as a server unit.

Since electronic components including a processing unit (CPU), a memory, an I/O port and a power source are densely mounted on the above-mentioned server unit, the server unit becomes extremely high temperature by being used continuously. Therefore, Japanese Patent Laid-Open Publication Nos. 2002-366258, 2003-61216, and 2003-99158 disclose the server apparatus in which a fan is attached to each drawer to cool the inside of the server apparatus.

However, in the server apparatus described in the above publications, not only the drawer has a box shape, but also each fan is attached to a rear plate or a side plate of the drawer. Accordingly, the size of the fan is limited, so that the large fan having a large air amount cannot be used. Since cooling ability of the small fan is low, each server unit cannot be good enough to be cooled by such a small fan. Therefore, in a prior art server apparatus, plural fans are attached to each drawer, thus leading to an increase of the device cost. To make matters worse, plural small fans having the high speed of rotation are used, so that an installation space for each fan which is partitioned with a partition or a sound barrier is required in the server apparatus.

### SUMMARY OF THE INVENTION

A primary object of the present invention is to provide an electronic apparatus in which cooling ability of a fan can be enhanced and noise from the fan can be reduced.

Another object of the present invention is to provide an electronic apparatus in which cost can be curbed.

In order to achieve the above and other objects, an electronic apparatus of the present invention includes at least one fan for sending a cooling air from the outside to the inside of an apparatus case, and a cutout, provided at least in a wall facing the fan and surrounding a bottom plate of the drawer, for providing the cooling air from the fan to a circuit unit provided in each drawer.

According to the preferred embodiment of the present invention, a drawer is contained in the apparatus case by sliding on a pair of guide members. The cutout is provided in a pair of side plates and a rear plate. The fan is attached on a rear or side surface of the apparatus case. When a diameter of the fan is φ and length of the narrow side of the surface of the apparatus to which the fan is attached is L, the following condition is met:
L/2≦φ<L.

According to the present invention, since the cutout is provided at least in the vertical wall facing the fan and surrounding the bottom plate of the drawer so as to provide the cooling air directly from the fan to the circuit unit of each drawer, so that cooling ability of the fan is enhanced. In addition, it is possible to reduce the noise from the fan by using the fan having a large diameter, so that an installation space for the fan is not needed. Furthermore, it is not necessary to use plural fans, so that the cost is reduced.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a front perspective view of a server apparatus to which the present invention is applied;

FIG. 2 is a front view of an apparatus case in a state that a front cover is removed;

FIG. 3 is a rear perspective view of the server apparatus;

FIG. 4 is a perspective view showing constitution of a server unit;

FIG. 5 is a perspective view showing constitution of a server unit in which there is no side plate and rear plate of a drawer in another embodiment of the present invention; and

FIG. 6 is a front perspective view of a server apparatus in which a fan is attached to a side surface of an apparatus case in further embodiment of the present invention.

### DETAILED DESCRIPTION OF THE PREFERRED EMBODIMENTS

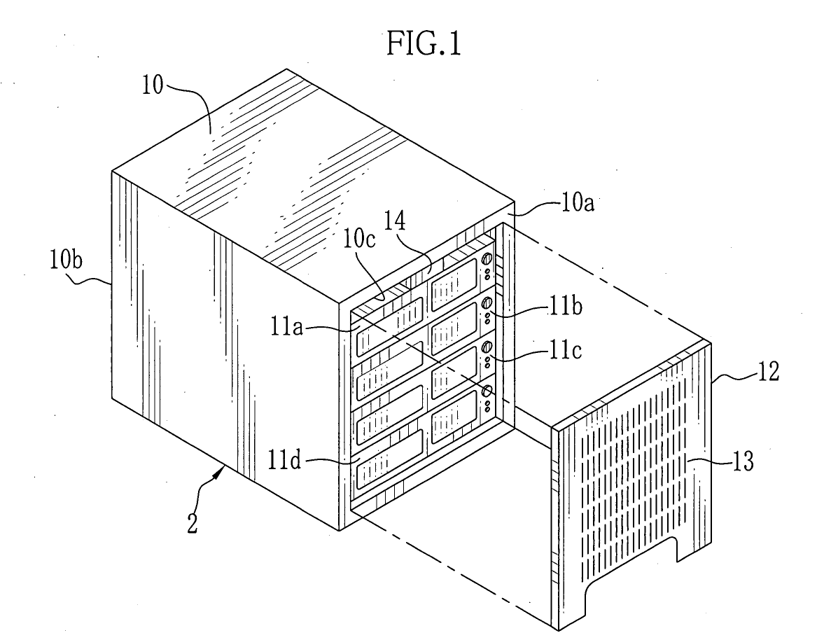

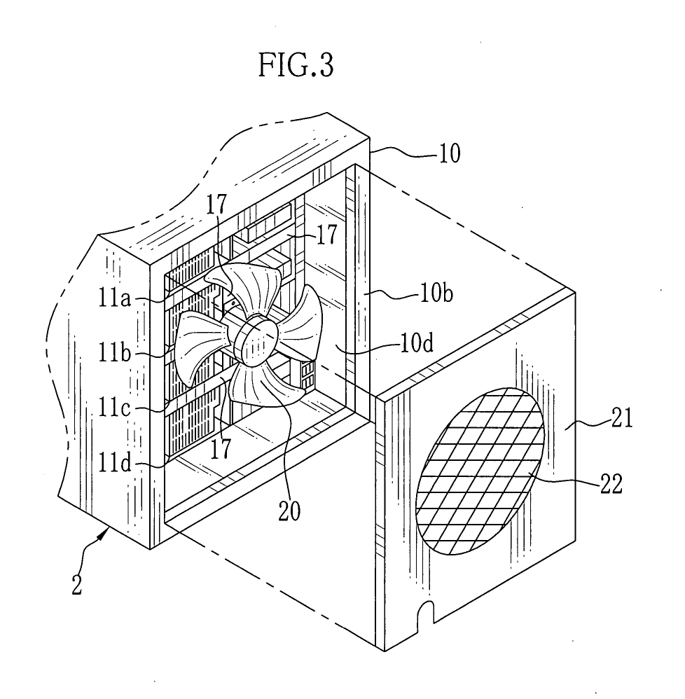

In FIG. 1, a server apparatus 2 is constituted of an aluminum apparatus case 10 having a box shape and drawers 11a-11d made of aluminum likewise. An opening 10c is formed in a front surface 10a of the apparatus case 10, while an opening 10d (see FIG. 3) is formed in a rear surface 10b. A front cover 12 and a rear cover 21, shown in FIG. 3, are respectively attached to the front and rear surfaces 10a, 10b by a screw and the like. The apparatus case 10 and drawers 11a-11d may be made of iron.

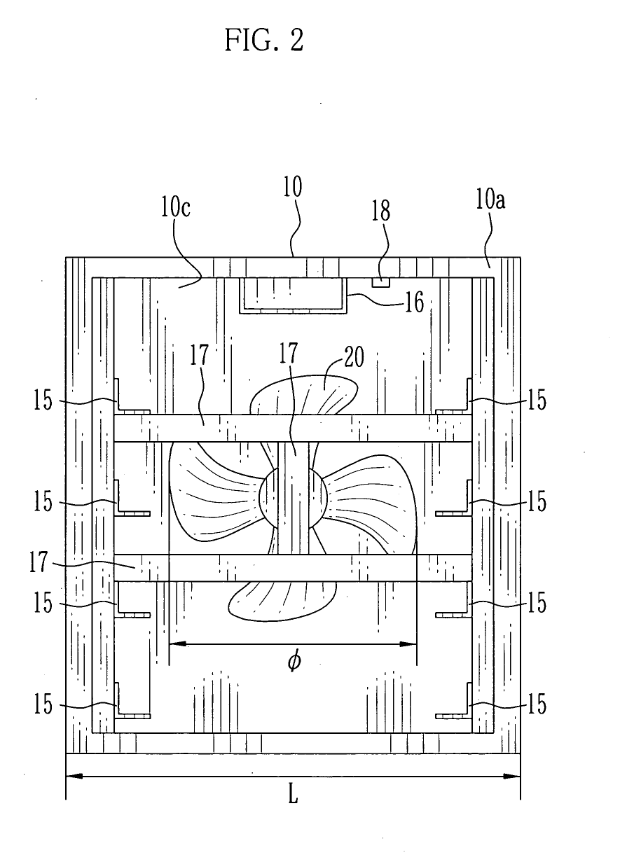

A vent hole 13 for discharging cooling air from a fan 20, shown in FIGS. 2 and 3, is formed in the front cover 12. A hub 14 is provided above the drawer 11a. The server apparatus 2 provides various services to plural terminals connected in a network through the hub 14.

In FIG. 2, L-shaped rail members 15 for holding the drawers 11a-11d in a slidable manner are attached to left and right inner walls of the apparatus case 10. A holding plate 16 for holding the hub 14 is attached above the inner wall. An attaching plate 17 for installing the fan 20 is fixed to the rear surface 10b. The rail members 15 are operated as a guide member when each drawer is inserted into the apparatus case 10 or pulled out from the side of the front surface 10a. The drawers 11a-11d are closely arranged in the apparatus case 10 each other by the rail members 15, so that the server apparatus 2 becomes compact in size and can be cooled more effectively by the fan 20.

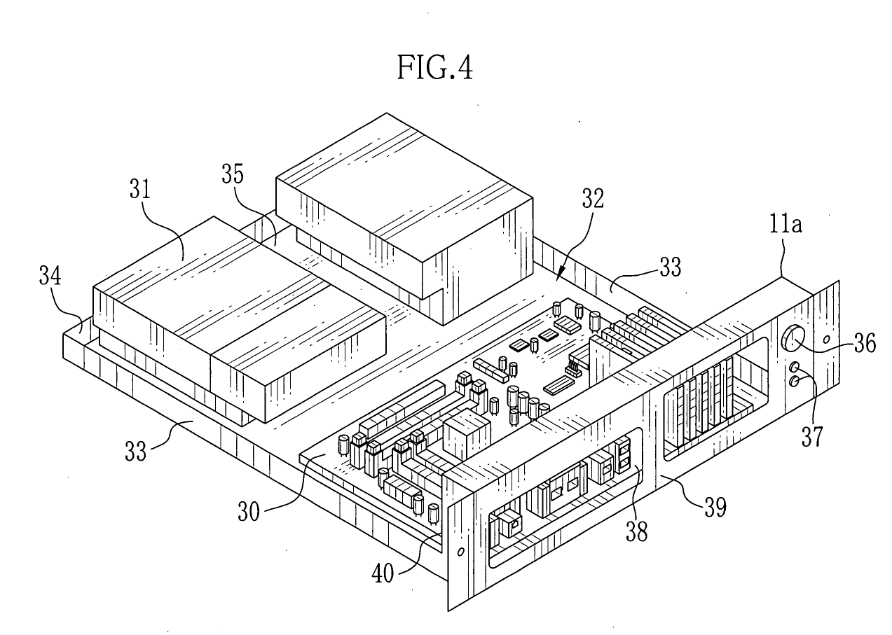

As shown in FIG. 3, the fan 20 and a rear cover 21 are attached to the rear surface 10b of the apparatus case 10. The fan 20 is fixed to the attaching plate 17 by the screw and the like so as to face the rear cover 21. The fan 20 is started to be rotated upon actuating a server unit 32 shown in FIG. 4, and introducing ambient air from a vent hole 22, which is formed in the rear cover 21. The vent hole 22 may be formed in a side surface of the apparatus case 10, other than the front and rear covers 12, 21.

As shown in FIG. 2, when a diameter of the fan 20 is φ and length of the narrow side of the surface to which the fan is attached (in this case, the rear surface 10b) is L, the following condition is met:
L/2≦φ<L.
The size of the fan 20 is preferably determined so as to meet the above formula. For example, a general type fan (UL-30A, (φ=30 cm) produced by Hitachi Home & Life Solutions, Inc. may be used.

As shown in FIG. 4, the server unit 32 is mounted in the drawer 11a. The server unit 32 is constituted of a circuit board 30 on which a computing device is mounted and a hard disk drive 31. The server units 32 of the drawers 11a-11d are connected with each other by the hub 14. Each server unit 32 is constituted of a file server which makes user share files in the network, a print server for administrating a printer in the network, an e-mail server for sending and receiving the e-mail, and so forth. These servers are operated separately according to their functions. Note that server units 32 may be operated in an interlocking relation to each other by mounting servers having the same function.

The drawer 11a is constituted of a pair of side plates 33, a rear plate 34, a bottom plate 35 to which the server unit 32 is attached, a power button 36, a display lamp 37 and a front plate 39 in which a connector inserting opening 38 for exposing various connectors is formed. Part of the side plate 33 and the bottom plate 35 are held by the rail members 15, so that the drawers 11a-11d can be inserted into or pulled out from the side of the front surface 10a of the apparatus case 10.

A cutout 40 is provided in the side plate 33 and the rear plate 34 so as to lower the height thereof. The cooling air from the fan 20 is directly provided to the server unit 32 by providing the cutout 40. Note that the drawers 11b-11c have the same constitution as the drawer 11a.

When each power button 36 of the drawers 11a-11d is pushed after supplying the power source to the server apparatus 2, the server unit 32 is activated, while the fan 20 is started to be rotated. Thereby, the ambient air is led from the vent hole 22 of the rear cover 21 into the apparatus case 10, so that the cooling air is provided to each server unit 32 of the drawers 11a-11d. The cooling air is used for cooling the heat generated in the server unit 32 after performing heat exchange with the server unit 32. After that, the cooling air is discharged outside of the apparatus case 10 through the vent hole 13 of the front cover 12.

In the present embodiment, it is possible to enhance both the air permeability and the workability at the time of maintenance by providing the cutout 40 in the side plate 33 and the rear plate 34 of each drawer. In addition, the drawers 11a-11d are arranged closely each other by providing the rail members 15, so that all the server units 32 can be cooled only by one fan 20. Accordingly, it is possible to take full advantage of the cooling ability of the fan 20. Moreover, the noise produced by the fan can be reduced by using the fan having the large diameter in addition to cooling the server unit 32 sufficiently. Therefore, since it is not necessary to ensure the installation space for the fan, the fan and other office automation equipments, such as a fax machine and a copy machine, can be arranged together side-by-side.

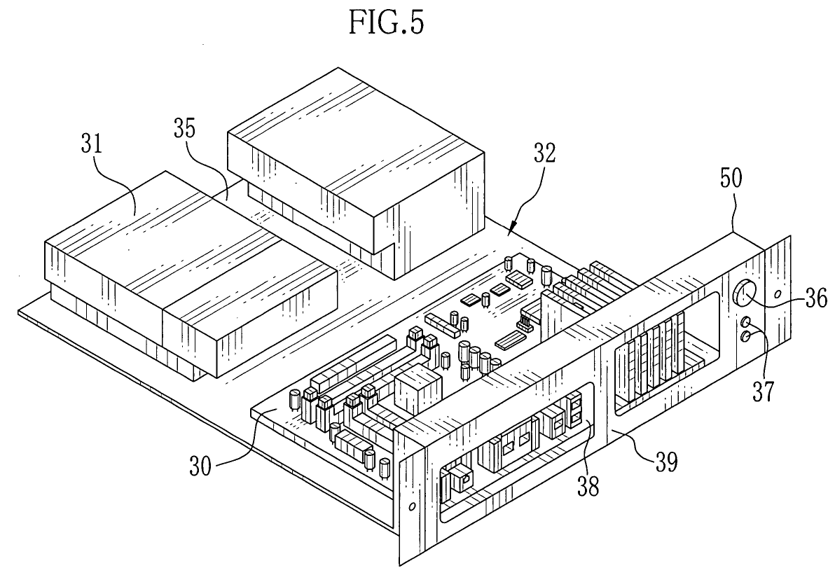

The cutout 40 may be provided at least in a wall of the drawer 11a facing the fan 20 (the rear plate 34 in the present embodiment) except for the front plate 39. Additionally, as shown in FIG. 5, the present invention may be applied to a drawer 50 which is constituted of the bottom plate 35 and the front plate 39 without the side plate 33 and the rear plate 34. In such constitution, it is possible to reduce the device cost.

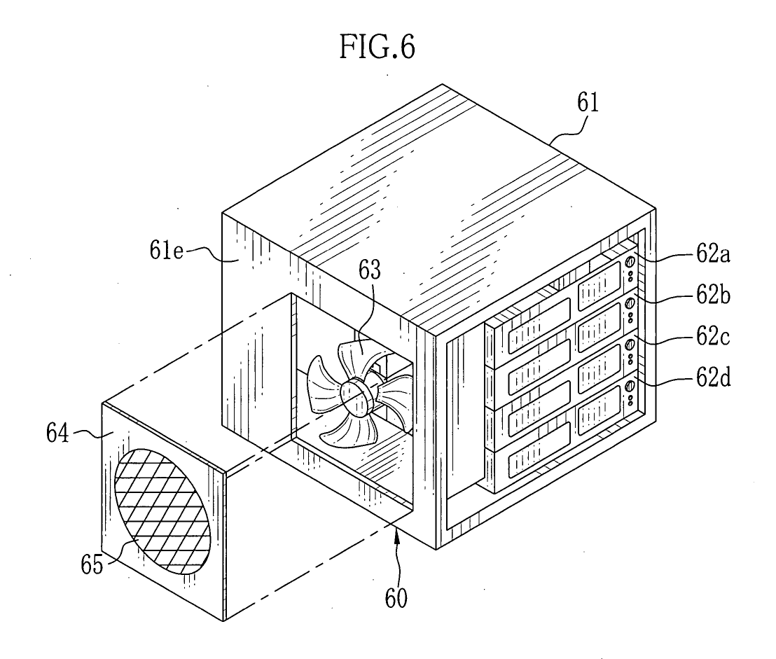

In the above embodiment, as shown in FIGS. 2 and 3, although the fan 20 is attached to the rear surface 10b of the apparatus case 10, a position where a heatable power supply unit of the server unit 32 is densely mounted may be cooled selectively by attaching a fan 63 to a side surface 61e of an apparatus case 61 as shown in FIG. 6, for example. In this case, the fan 63 introduces the ambient air from a vent hole 65 formed in a side cover 64. As in the above embodiment, the cooling air introduced by the fan 63 is used to cool the whole of the server unit 32 and discharged outside of the apparatus case 61 from a vent hole of a front cover.

In addition, the above embodiment is not limited only to four (4) server units, but is also applicable to, for example, two (2), five (5), eight (8) or sixteen (16) server units according to the specification of the server apparatus 2. However, in order to ensure a minimum of cooling ability, it is necessary to increase the number of the fans corresponding to the addition of the server unit. For example, if sixteen (16) server units are used, eight (8) server units are arranged two wide in order to allow for compact the dimension in the longitudinal direction of the server apparatus 2, and three (3) fans are arranged in the longitudinal direction on a side surface of the apparatus case. Accordingly, a total of six (6) fans are provided.

Moreover, the rotation speed of the fan 20 may be changed in response to the temperature in the apparatus case 10 by providing a thermometer 18 (see FIG. 2) in the apparatus case 10. If the temperature in the apparatus case 10 is extremely high, it is preferable to increase the air amount.

Furthermore, although the server apparatus is explained as the electronic apparatus, a storage, a router, an amplifier, a power source, a measuring device, a communication apparatus and the like may be applied to the present invention.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An electronic apparatus including an apparatus case, which is formed in the shape of a box of which front surface is open and has plural guide members therein, plural drawers installed into said apparatus case and pulled out from a front surface side by being guided by each of said guide members, and a circuit unit attached onto a bottom plate of each of said drawers, said electronic apparatus comprising:
at least one fan, attached to said apparatus case, for sending cooling air from outside of said apparatus case to inside thereof; and
a cutout, formed at least in a wall surrounding said bottom plate of said drawer and facing said fan, for providing said cooling air from said fan to said circuit unit of each of said drawers.

2. An electronic apparatus as claimed in claim 1, wherein said circuit unit is a server unit.

3. An electronic apparatus as claimed in claim 2, wherein said cutout is formed in a pair of side plates and a rear plate of said drawer, except for a front plate thereof.

4. An electronic apparatus as claimed in claim 3, wherein said drawer, of which a pair of said side plates and said rear plate are completely removed, comprises said bottom plate and said front plate.

5. An electronic apparatus as claimed in claim 3, wherein said fan is attached to a rear surface or a side surface of said apparatus case.

6. An electronic apparatus as claimed in claim 5, wherein when a diameter of said fan is p and length of a narrow side of a surface of said apparatus case to which said fan is attached is L, the following condition is met:
L/2≦φ<L.

7. An electronic apparatus as claimed in claim 5, further comprising a thermometer for controlling a rotation speed of said fan in response to a temperature in said apparatus case.
